(19) United States
(12) Patent Application Publication
(10) Pub. No.: US 2004/0026594 A1
(43) Pub. Date: Feb. 12, 2004

(54) Mobile Chrismas tree stand apparatus

(76) Inventor: Deborah Lynn Lee, Friendswood, TX (US)

Correspondence Address: Deborah Lynn Lee, 16819 Anchor Park, Friendswood, TX, 77546, US

(21) Appl. No.: 10/213,552

(22) Filed: Aug. 8, 2002

(51) Int. Cl. F16M 13/00

(52) U.S. Cl. 248/523; 248/519

(57) ABSTRACT

A mobile Christmas tree stand apparatus comprised of three components, a Christmas tree stand body (1) a plurality of removable wheels (2) and a removable handle; wherein the Christmas tree stand body is attached to the removable wheels (2) and the removable handle (3).

### BACKGROUND

1. Field of Invention

This invention relates generally to Christmas tree stands, specifically to such devices used for translating and rotating a Christmas tree.

2. Description of Prior Art

One of the challenges in the display of a Christmas tree is the ability to easily maneuver the tree to a location and orientation so that the tree is displayed in the position of most aesthetically attractive viewing. Most Christmas tree stand manufacturers build such stands so that the base of the stand is supported by a plurality of appendages extending to the floor or ground. After assembly and mounting of the tree to such stands and subsequent decoration, the tree and stand can not be easily moved without dragging the stand across the ground or floor in an awkward and damaging manner.

### PRIOR ART

Existing Christmas tree stand designs generally include extending appendages prone to damage flooring and difficult to move when fully loaded with a tree and decorations. See U.S. Pat. Nos. 6,370,816, 6,019,341, 5,987,813, 5,979,859, 5,862,883, 5,845,890, 5,779,215, 5,732,936, 5,557,701, 5,522,177 and 5,492,301.

### OBJECTS AND ADVANTAGES

Accordingly, objects and advantages of the present invention include:

Provision of a method to easily move a Christmas tree with its stand and without disassembly and without damage to the stand, floor or ground.

### SUMMARY, RAMIFICATIONS, and SCOPE

In accordance with the present invention, a mobile Christmas tree stand apparatus comprises a Christmas tree stand with a plurality of removable wheels that attach to the Christmas tree stand, flip-switch brakes for each wheel attached to the removable wheels and a removable handle attached to the Christmas tree stand and adapted to aid in moving the assembled tree and stand.

Thus the reader will see that the mobile Christmas tree stand of the present invention provides a highly reliable, economical, convenient device to aid the family in display and care for a Christmas tree.

While the above description contains specificity, this specificity must not be construed as limitations on the scope of the invention, but rather as an exemplification of one preferred embodiment thereof.

Accordingly, the scope of the invention should be determined not by the embodiment(s) illustrated, but by the appended claims and their legal equivalents.

### DESCRIPTION OF DRAWINGS

### REFERENCE NUMERALS IN DRAWINGS

1 Christmas Tree Stand

2 Removable wheels

3 Removable handle

### BRIEF DESCRIPTION OF THE DRAWINGS

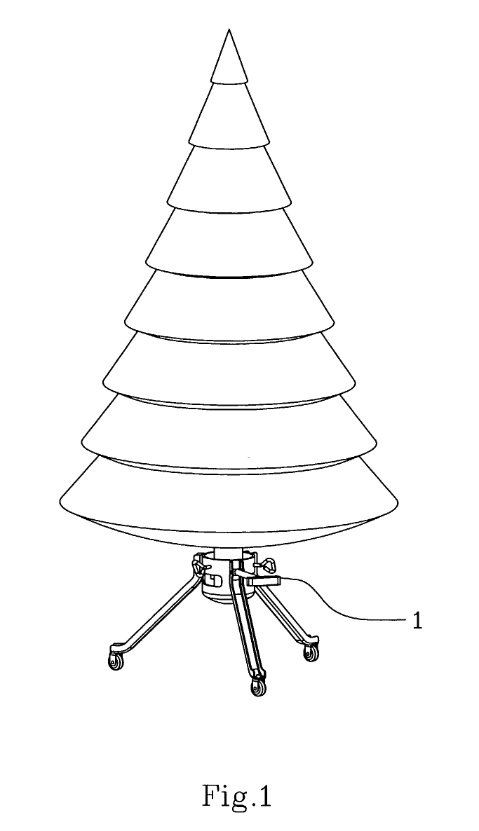

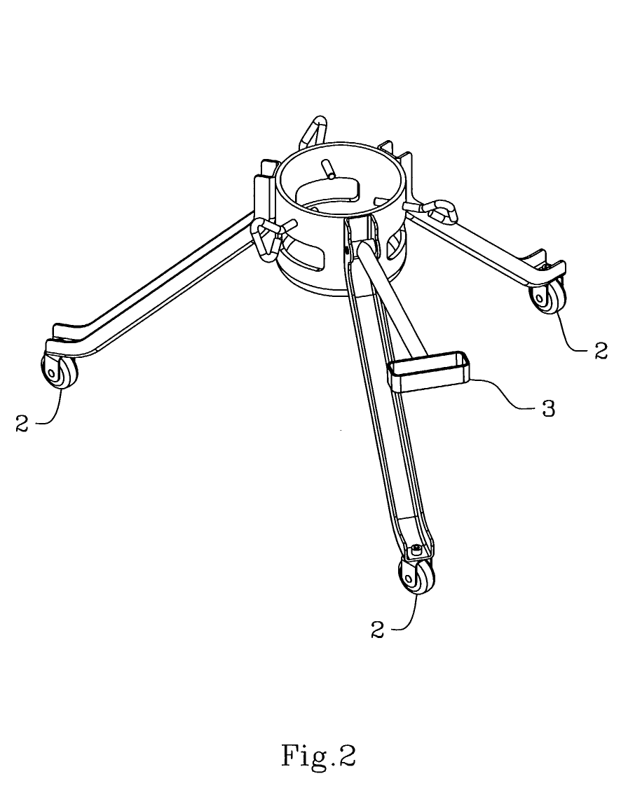

FIG. 1 shows the isometric aspect of a mobile Christmas tree stand apparatus.

### DESCRIPTION OF THE PREFERRED EMBODIMENTS

A typical view of the mobile Christmas tree stand apparatus is illustrated in FIG. 1 (isometric view). The mobile Christmas tree stand apparatus may be adhesively or mechanically attached to a plurality of removable wheels and may be adhesively or mechanically attached to the removable handle.

I claim:

1. A mobile Christmas tree apparatus comprising a Christmas tree stand attached to a plurality of removable wheels, as a means for maneuvering a Christmas tree.

2. A mobile Christmas tree apparatus per claim 1 wherein said Christmas tree stand further includes a removable handle as a means for maneuvering a Christmas tree.

3. A mobile Christmas tree apparatus per claims 1 wherein said removable wheels further include brakes as a means for controlling movement of a Christmas tree.
